(19) United States
(12) Patent Application Publication
(10) Pub. No.: US 2014/0028018 A1
(43) Pub. Date: Jan. 30, 2014

(54) Locking Nipple for Electronic Sensors

(71) Applicant: The Watt Stopper, Inc., Carlsbad, CA (US)

(72) Inventors: Louia Weidman, Carlsbad, CA (US); Todd Hu, Carlsbad, CA (US)

(73) Assignee: The Watt Stopper, Inc., Carlsbad, CA (US)

(21) Appl. No.: 13/950,029

(22) Filed: Jul. 24, 2013

Related U.S. Application Data
(60) Provisional application No. 61/677,172, filed on Jul. 30, 2012.

(51) Int. Cl. F16L 37/12

(52) U.S. Cl. CPC F16L 37/12
USPC 285/140.1

(57) ABSTRACT

A nipple adapter is provided to secure a sensor to a fixture to be controlled by the sensor. The nipple adapter includes a collar bushing to be blind fitted to an opening in the fixture. A cooperating nipple is secured to the sensor and the nipple is press fit into the collar bushing and the sensor and nipple are rotated to engage locking structures in the collar bushing and secure the sensor and nipple adapter to the fixture.

### RELATED APPLICATIONS

This application claims priority from U.S. Provisional Patent application 61/677,172 filed Jul. 30, 2012.

### FIELD OF THE INVENTIONS

The inventions described below relate to the field of accessories for electrical construction components and more specifically to press-to-fit adapters for securing electrical housing components together.

### BACKGROUND OF THE INVENTIONS

Occupancy sensors are commonly attached to lighting fixtures to control the light output of the fixture based on occupancy (or vacancy) status of the space containing the fixture. It is common practice to provide a threaded nipple on the occupancy sensor that can be inserted into a hole in a wall of a fixture and secured with a nut from within the fixture to attach the sensor to the fixture. Attaching the sensor to the fixture requires that the fixture be partially disassembled in order to thread the nut on to the threaded nipple from the inside of the fixture.

Some sensors may be provided with female threads that may accept a threaded nipple adapter, but this requires three nuts for mounting; one to lock one end of the adaptor against the sensor and the other two to lock the other end of the adaptor against the fixture wall (fixture wall is sandwiched between the two nuts). One of the nuts for the fixture may be eliminated by providing a stop collar. Manipulating and tightening of these nuts requires multiple steps and adds considerably to the time it takes to connect the sensor to the fixture and that drives up the cost of the combined product.

### SUMMARY

The devices and methods described below provide for a nipple adapter with a sensor nipple engaging an expandable collar bushing, where the collar bushing is pressed blindly into the wall of a fixture, then a sensor with a cooperating nipple attached, the sensor nipple, is inserted into the collar bushing and, with a turn of the nipple and sensor, the sensor nipple engages a locking mechanism in the collar bushing that reliably secures the sensor and the engaged elements of the nipple adapter to the fixture.

The collar bushing includes one or more locking structures such as sliding or bending structures that extend from the outer walls of the collar bushing when the sensor nipple is engaged and rotated relative to the collar bushing. These locking structures then engage the fixture wall to create a pressure fit that locks the bushing, the engaged sensor nipple and the sensor to the fixture wall.

When extended by insertion of a cooperating nipple into the collar bushing, the locking structures will hold the bushing into the fixture wall so that it cannot be removed with the sensor nipple inserted. The bushing may be removed from the fixture wall by removing the sensor nipple and then removing the bushing from the fixture wall if desired. The bushing also has an internal bore sized to allow wires, and wire terminations to electrically connect the sensor and fixture electronics, and for the electrical connection to be performed outside of the fixture using small wire nuts as are known in the art, and then push the completed connections through the internal bore and into the fixture as a prelude to inserting the sensor nipple and locking the sensor to the fixture.

The sensor enclosure or housing may include a cooperating nipple, the sensor nipple, co-molded to the housing with a central bore through which the termination wires of the sensor protrude. Sensor nipples may be produced separately from the sensor housing and secured to the housing with any suitable technique or fastener.

The expandable or locking structures of the collar bushing may be designed to withstand forces applied during reliability tests, however, the intent of the design is that forces applied to the sensor housing are transmitted to the sensor nipple which then transmits the applied forces to the collar bushing and then to the fixture wall. As such, the expandable or locking structures do not need to be able to withstand the majority of the applied force and thereby allowing flexibility in the design and orientation of the expandable or locking structures.

Sensors may also be secured to a fixture via an intervening extension module that allows the sensor to be oriented away from the fixture. Where extension modules are used, a cooperating nipple may be formed on one or both ends of the extension module for engaging a collar bushing in a fixture and a collar bushing in the sensor housing with the other end. Alternatively, the sensor housing may have the collar bushing molded into the housing. The extension module may have sensor mounting holes along its length so that the sensor may be mounted in a preferred position during assembly of the fixture and sensor.

### BRIEF DESCRIPTION OF THE DRAWINGS

FIG. 1 is a perspective view of a sensor with sensor nipple attached oriented to engage a collar bushing.

FIG. 2 is a side view of a collar bushing engaging a fixture wall.

FIG. 3 is a perspective view of the insertion end of a collar bushing.

FIG. 4 is a perspective view of the collar end of a collar bushing.

FIG. 5 is a side view of a sensor nipple secured to a sensor housing.

FIG. 6 is an end view of the sensor nipple and housing of FIG. 5.

FIG. 7 is an exploded view of a sensor, extension module and fixture box with intervening nipple adapters.

### DETAILED DESCRIPTION OF THE INVENTIONS

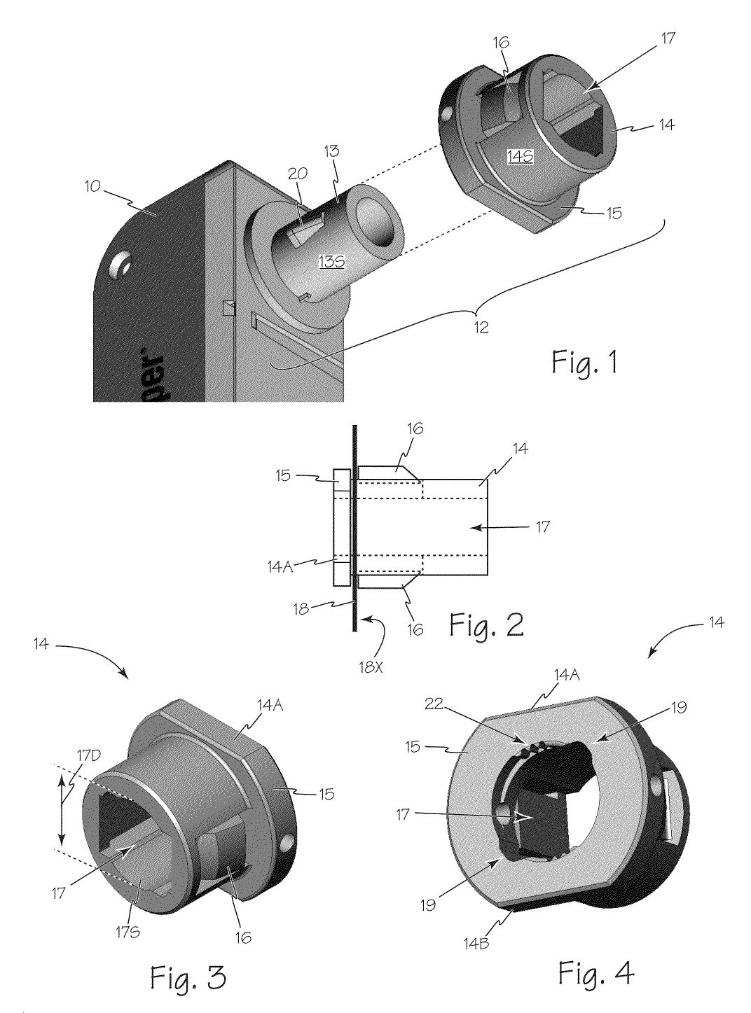

Occupancy sensor 10 of FIG. 1 is secured to a fixture housing using locking nipple adapter 12 which is composed of sensor nipple 13 and collar bushing 14. Collar bushing 14 includes one or more locking structures that may be configured as sliding or bending structures, such as locking structures 16, that extend beyond outer surface 14S of the collar bushing when sensor nipple 13 is inserted into bushing bore 17 and rotated relative to the collar bushing. Locking structures 16 then engage fixture wall 18 as illustrated in FIG. 2 to create a pressure fit that locks the bushing, the engaged sensor nipple and the sensor to the fixture wall.

When extended by insertion of a cooperating nipple into the collar bushing, locking structures 16 will hold the bushing into fixture wall 18 so that it cannot be removed with the sensor nipple inserted. The bushing may be removed from the fixture wall by removing the sensor nipple and then removing the bushing from the fixture wall if desired.

Internal bore 17 has diameter 17D which is sized to allow wires, and wire terminations to electrically connect the sensor and fixture electronics, and for the electrical connection to be performed outside of the fixture using small wire nuts as are known in the art, and then push the completed connections through the internal bore and into the fixture as a prelude to inserting the sensor nipple and locking the sensor to the fixture.

The expandable collar bushing may be formed as a single molded plastic piece. As illustrated in FIGS. 3 and 4, collar bushing 14 may also include two opposing flat surfaces 14A and 14B on collar 15 to enable an installer to control rotation of the collar bushing while the sensor nipple is rotated relative to the collar bushing. In addition or in lieu of the opposing flat surfaces, one or more holes may be provided that allow a tool, such as a #1 Philips screwdriver, or a fastener, such as a screw or pin to be inserted to engage the fixture to prevent rotation of the collar bushing. Collar bushing 14 may also include cutouts or openings such as openings 19 that allow the sensor nipple cam structures to be inserted into the bushing and align the cam structures to the expandable or locking structures in the bushing.

Referring again to FIG. 2, the expandable or locking structures such as locking structures 16 in the collar bushing may be designed to press fit against fixture wall 18 and provide elements that, when engaged with the sensor nipple, are pushed along inner surface 18X of the fixture wall wherein movement of the locking structures is in a plane parallel to surface 18X of the fixture wall. This prevents collar bushing 14 from being able to be pulled out of the fixture hole when the sensor nipple is engaged. Alternatively, expandable or locking structures may be oriented to move along a plane perpendicular to fixture wall surface 18X. A diagonal or spiral oriented locking structure may also be used. At least one locking structure is required, better strength and stability are provided with at least two locking structures. Any suitable configuration of locking structures may be used, non-geometric orientation of multiple expandable structure may be used, for example, if there are known force vectors that will be applied to the sensor, then a greater number of expandable structure may be oriented to counter those forces with at least one expandable structure opposite of this location to provide symmetrical engagement force between the nipple adapter and the fixture.

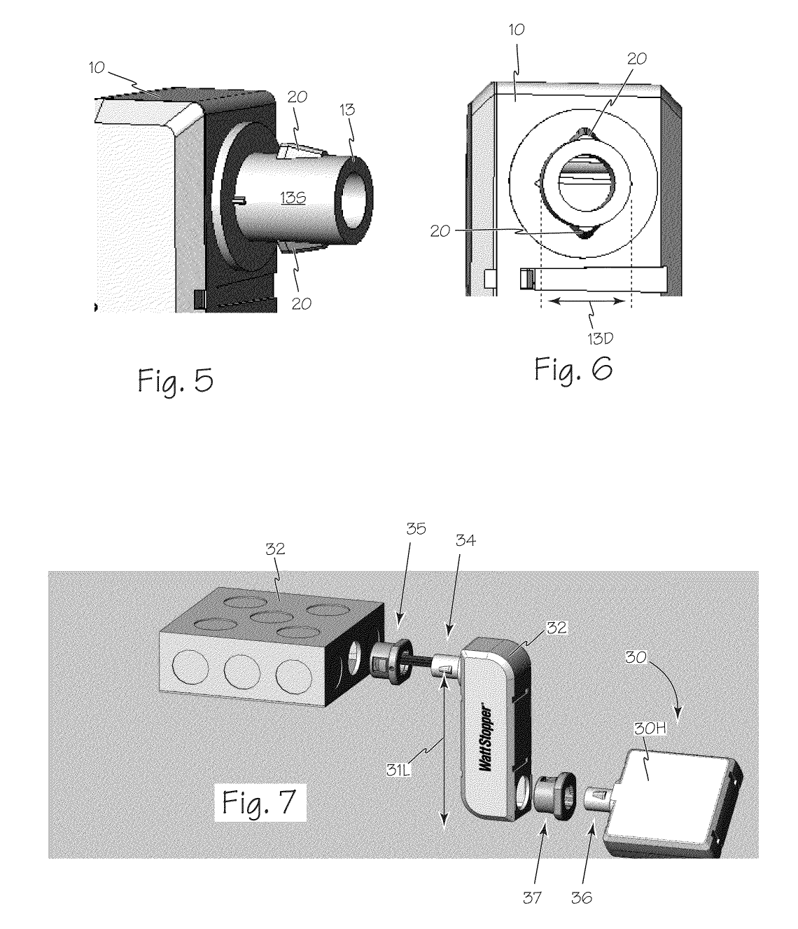

As illustrated in FIGS. 5 and 6, the outside wall, surface 13S, of the sensor nipple includes two raised cams, locking cams 20, for engaging the collar bushing and activating the locking structures 16 of the collar bushing. Rotating the sensor nipple relative to the collar bushing causes the cam structures to engage the expandable or locking structures in the bushing to extend beyond bushing outer surface 14S to secure the collar bushing against fixture wall 18. Force coupling between the nipple cams and the expandable or locking structures retains the sensor nipple and the sensor to the collar bushing. As shown in FIG. 4, one or more rotation stops such as rotation stops 22 may be molded into or secured to the bushing to prevent over rotation of the sensor nipple.

Because outer diameter 13D of the sensor nipple and inner diameter 17D of the collar bushing bore must be sufficiently different to allow easy insertion and rotation between the sensor nipple and the collar bushing, there will be some movement between surfaces 13S and 17S when the sensor nipple is in its locked position. Secondary locking or surface engaging structures may be provided, preferably near the sensor-engaging side of the collar and the base of the nipple that absorb or take up any relative movement between the nipple and bushing. One or more secondary locking structures may be provided in order to distribute stress force applied to the sensor nipple to multiple points on the collar bushing and minimizing any point loading that may cause one or more of the nipple adapter components to fail under stress loading.

Sensors such as sensor 30 of FIG. 7 may also be secured to a fixture via an intervening extension module, extension module 31, that allows the sensor to be oriented away from fixture 32. Where extension modules are used a cooperating nipple, such as nipple 34 may be formed on one or both ends of the extension module for engaging collar bushing 35 in fixture 32. A second nipple on the extension module may then engage a collar bushing in the sensor housing. Alternatively as shown, a cooperating nipple, nipple 36 may be integrated in sensor housing 30H to engage collar bushing 37 which is inserted into extension module 31. A collar bushing may also be molded into the sensor housing to engage a second nipple integrated into the extension module. The extension module may have two or more sensor mounting holes along its length 31L so that the sensor may be mounted in a preferred position during assembly of the fixture and sensor.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A sensor mounting apparatus comprising:
a collar bushing having an outer flange and one or more locking structures for securing the collar bushing to an opening in a fixture housing;
a nipple secured to a sensor housing, the nipple including one or more cams for engaging the one or more locking structures and securing the nipple and sensor to the collar bushing in the fixture housing.
